(19) United States
(12) Patent Application Publication
(10) Pub. No.: US 2014/0258347 A1
(43) Pub. Date: Sep. 11, 2014

(54) GROUPING FILES FOR OPTIMIZED FILE OPERATIONS

(71) Applicant: MICROSOFT CORPORATION, Redmond, WA (US)

(72) Inventor: Chetley T. Laughlin, Seattle, WA (US)

(73) Assignee: MICROSOFT CORPORATION, Redmond, WA (US)

(21) Appl. No.: 13/794,447

(22) Filed: Mar. 11, 2013

(51) Int. Cl. G06F 17/30

(52) U.S. Cl. CPC G06F 17/30091
USPC 707/824

(57) ABSTRACT

Various techniques and solutions are described for grouping files for optimized file operations. For example, file operations (e.g., standard file operations) can be received for a grouped plurality of files. Data related to the file operations can be stored in a cache. Optimized file operations can then be determined. For example, optimized file operations can be determined and performed for updating sectors used information, for writing file data (e.g., from the cache), for updating folder meta-data information, and/or for performing other file-related activity. Optimized file operations can be performed for writing data to external secondary storage. Grouping files for optimized file operations, such as file writes, can be more efficient than writing multiple independently optimized single file patterns. An application programming interface (API) can be provided to receive, group, and optimize file operations from services and applications.

### BACKGROUND

Devices, such as mobile phones and tablets, often have limited internal memory, such as flash memory, for storing files. In order to compensate for the limited internal memory, such devices often provide for expanding the storage capacity of the device using external memory cards, such as Secure Digital (SD) memory cards or Universal Serial Bus (USB) memory sticks. While external memory cards can significantly increase the storage capacity of the device, they are generally slower to access than internal memory.

Some attempts have been made to speed up access to external memory cards at the block and file level, such as using larger block sizes. While such attempts may provide some improvement when writing a portion of a file for example, they may not provide optimization at a higher level, such as when writing multiple files or performing other file-related operations.

Therefore, there exists ample opportunity for improvement in technologies related to optimizing file operations.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and tools are described for grouping files for optimized file operations. For example, file operations (e.g., standard file operations) can be received for a plurality of files. Data related to the file operations can be stored in a cache. Optimized file operations can then be determined. For example, optimized file operations can be determined and performed for updating sectors used information, for writing file data (e.g., from the cache), for updating folder meta-data information, and/or for performing other file-related activity. Optimized file operations can be performed for writing data to external secondary storage.

For example, a method can be provided for grouping files for optimized file operations. The method can be performed, for example, by a file optimizer component of a computing device. The method comprises receiving a request to perform file operations for a plurality of files, receiving an indication of the plurality of files, for each file of the plurality of files receiving an indication of one or more file operations to perform for the file, determining optimized file operations for the plurality of files, and performing the optimized file operations using external secondary storage of the computing device. Data related to the one or more file operations can be stored in a cache.

As another example, a method can be provided for grouping files for optimized file operations. The method can be performed, for example, by a file optimizer component of a computing device. The method comprises receiving a request to perform file operations for a plurality of files, and for each file of the plurality of files: receiving an indication of the file, receiving one or more file operations to perform for the file, caching data associated with the one or more file operations to perform for the file, and receiving an indication that file operations are complete for the file. The method further comprises determining and performing a single optimized file operation to update a sectors used table on external secondary storage of the computing device, determining and performing optimized file operations to write the cached data for the plurality of files to the external secondary storage, and determining and performing optimized file operations to update folder meta-data associated with the plurality of files on the external secondary storage.

As another example, computing devices comprising processing units, memory, and external storage cards can be provided for performing operations described herein. For example, a mobile computing device, such as a mobile phone, can include a file optimizer component for grouping files for optimized file operations.

As described herein, a variety of other features and advantages can be incorporated into the technologies as desired.

### BRIEF DESCRIPTION OF THE DRAWINGS

FIG. 1 is a block diagram of an example computing environment for performing various file optimization techniques described herein.

FIG. 2 is a flowchart of an example method for grouping files for optimized file operations.

FIG. 3 is a flowchart of another example method for grouping files for optimized file operations.

FIG. 4 is a flowchart of an example method for grouping files for optimized file operations using cache memory and external secondary storage.

FIG. 5 is a diagram of an example control flow for grouping files for optimized file operations.

FIG. 6 is a diagram of an exemplary computing system in which some described embodiments can be implemented.

FIG. 7 is an exemplary mobile device that can be used in conjunction with the technologies described herein.

FIG. 8 is an exemplary cloud-support environment that can be used in conjunction with the technologies described herein.

### DETAILED DESCRIPTION

### Example 1

### Overview

As described herein, various techniques and solutions can be applied to grouping files for optimized file management. For example, files can be grouped for optimized writing, moving, deleting, sector updates, folder updates, and/or other file related operations. Grouping files for optimized file management can provide advantages including reducing random sequences in write operations and/or increasing the length of write sequences.

In the techniques and solutions described herein, information from upper level services and/or applications is utilized to optimize file operations, such as those performed by a file storage component or caching component. By utilizing upper level information about file operations, optimizations can be implemented that are not just specific to a portion of a file, but are applied across multiple files and/or folders. For example, this can allow a large amount of data to be made sequential in nature and thus increase bandwidth utilization when accessing storage devices, such as slower secondary storage devices. Furthermore, updates to folder and partition organizational blocks (e.g., File Allocation Table (FAT) maps, folder structure lists, etc.) can be reduced (e.g., using fewer operations or just a single operation) while providing updates to multiple files.

In an example optimization scenario, services and applications can notify a storage stack that a series of operations are going to be performed together (e.g., as a group). For example, four files may be written in order to install a new software application. The storage stack can receive the series of operations (e.g., standard file operations). In some implementations, the storage stack stores data in a cache. At the end of the series of operations, the storage stack can determine and perform optimized operations (e.g., aggregated operations). For example, if four files are to be written in order to install a new software application, the storage stack can perform a single write sequential sequence covering all four files (e.g., written from the cache) followed by a reduced number of folder and partition overhead updates. Similar savings can be realized for other grouped operations, such as moving a folder of files, deleting many files to uninstall an application, updating several files when editing a movie, etc.

The techniques and solutions described herein provide advantages when performing file operations for multiple files, and in some circumstances can provide advantages for single files as well. For example, the techniques and solutions can improve performance of writing multiple picture files, movie files, or other files to secondary storage, such as external storage cards.

### Example 2

### Secondary Storage

In any of the examples herein, computing device storage is segmented into primary storage (e.g., RAM), internal secondary storage, and external secondary storage. Internal secondary storage refers to relatively fast storage that is typically internal, or built-in, to the computing device. Examples of internal secondary storage include hard drives, solid-state drives (SSDs), built-in flash storage, etc. External secondary storage refers to relatively slow storage (relatively slower than internal secondary storage) that is typically not built-in to the computing device (e.g., that is connected, or plugged in, to the computing device via a slot or external connector). Examples of external secondary storage include Secure Digital (SD) cards, MultiMediaCard (MMC) storage cards, Universal Serial Bus (USB) flash drives, etc.

External secondary storage devices are relatively slow storage devices (relatively slower than internal secondary storage or primary storage). For example, external secondary storage devices (e.g., external secondary storage cards) typically have limited bandwidth and/or slower access times compared to internal secondary storage devices (e.g., hard drives). Furthermore, many external secondary storage devices are slower at random operations in relation to sequential operations.

### Example 3

### File Optimization Example

Performing file writes without using the optimization techniques and solutions described herein can involve many operations per file. The following example pseudo-code depicts operations typically performed when writing files (e.g., when writing files using typical or standard file system operations):

1. For each file:
a. Application/Service gets a file handle
b. For each write operation
   i. First, the storage media updates the sectors being used table
   ii. The data is then written in chunks/blobs of a particular size (e.g., a multiple of 512 bytes)
c. The folder meta-data is then updated
   i. New file entry
   ii. Or, new file length

Consider an example situation where three new files are being written, where the four new files are 512 KB each and are written using 4 KB chunks. Using the above pseudo-code (e.g., using standard file system operations), writing the four files would require performing:
512 sector update operations for the 1(b)(i) step (128 sector update operations for each file)
512 data write operations for the 1(b)(ii) step (128 data write operations per file, each data write for a 4 KB chunk of the 512 KB file)
4 folder meta-data operations for the 1(c) step (one folder meta-data operation for each file)

As illustrated by this example, writing a file using typical file storage solutions can involve many separate operations per file. In the above example, 1,028 separate operations are required to write just four 512 KB files. The large number of operations and their sequencing can significantly affect storage performance, particularly when using slower external secondary storage (e.g., SD cards).

Using the techniques and solutions described herein, file operations can be optimized (e.g., aggregated) to provide for more efficient utilization of storage resources (e.g., bandwidth, response time, etc.). Using the above example of writing four new files that are 512 KB each, the following optimized operations can be performed:
1 sector update operation (e.g., by first receiving and caching all of the file operations or receiving notice of the final file sizes and calculating the sectors that will be used upon writing all four files)
2 data write operations (e.g., by first receiving and caching all of the individual data writes and aggregating the writes into two 1 MB data write sequences, each data write sequence writing data for two of the four files)
1 folder meta-data operation (e.g., by combining folder updates for the four new files into a single meta-data update operation)

As illustrated above, using the techniques and solutions described herein can significantly reduce the number of operations needed to perform file management. As the above example situations illustrate, when writing four 512 KB files, 1,208 individual operations (e.g., most or all of which may need to separately access the storage device) can be reduced to 4 individual optimized operations.

The original (non-optimized) operations suffered a random sequencing with writes tracking sector usage (step (b)(i) above) being mixed in with the actual data writes. This random sequencing can dramatically slow down the speed (compared to a sequential sequence) in which the operations are completed on the external memory. Using optimized file operations, a single update can be performed at the start (for example on an exFAT (Extended File Allocation Table) partition updating the free space bitmap) so the data writes can then all be sequential (exFAT is a file system provided by Microsoft Corporation).

### Example 4

### Environment for Optimized File Operations

In any of the examples herein, a computing device, such as a mobile phone, tablet, or other type of computing device, can support components for grouping files for optimized file operations. For example, a file optimizer component can be implemented within an operating system and/or within another component (e.g., by a driver) of the computing device.

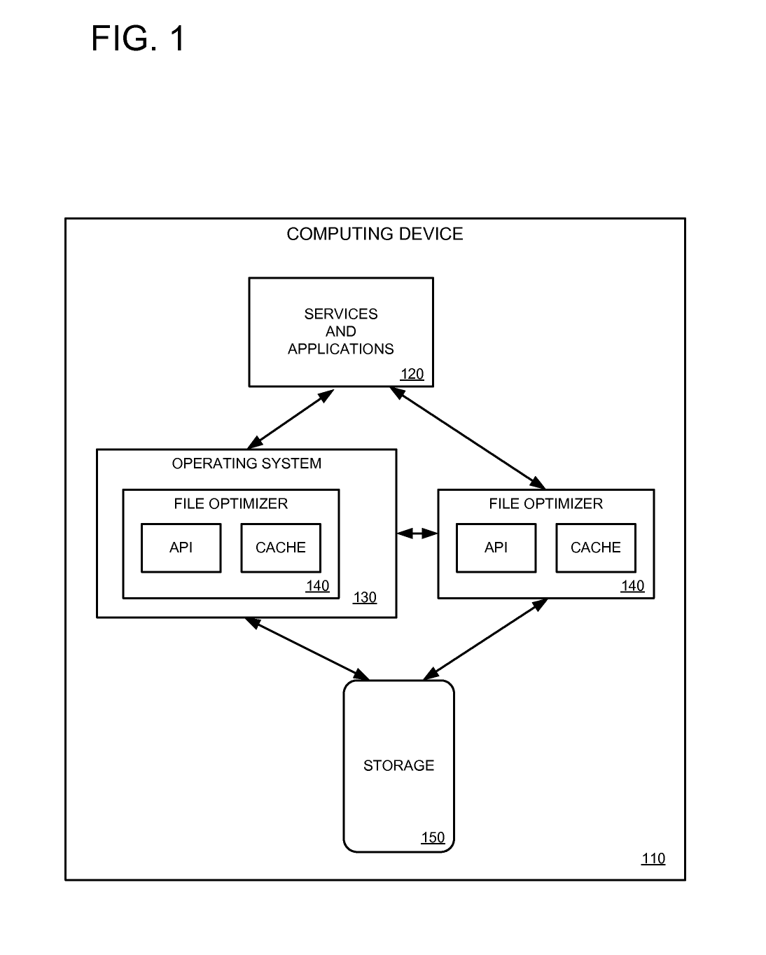

FIG. 1 is a diagram depicting an example computing device 110 within which the technologies and solutions described herein can be implemented for grouping files for optimized file operations. The computing device 110 comprises services and applications 120. The services and applications 120 represent various software services and software applications running on the computing device 110. Examples of services and applications 120 include a movie editing application, a music application, a software installer application, a file browser application, etc.

The computing device 110 comprises an operating system 130. The operating system can control operation of the computing device 110, such as file system operation and memory management.

The computing device comprises storage 150. The storage 150 can be internal secondary storage and/or external secondary storage. In some implementations, the storage 150 is external secondary storage (e.g., an SD card).

The computing device 110 can be any type of computing device (e.g., desktop computer, server computer, laptop computer, notebook computer, tablet computer, mobile phone, smart phone, multimedia device, personal digital assistant (PDA), etc.). In some implementations, the computing device 110 is a mobile phone or tablet computer that uses external secondary storage (e.g., a SD card or MMC card) as additional file storage (e.g., to expand a limited amount of internal secondary storage).

The computing device 110 comprises a file optimizer 140 component. The file optimizer can be implemented in software and/or hardware of the computing device 110. As depicted in FIG. 1, the file optimizer 140 can be implemented as part of the operating system 130 of the computing device and/or as a separate component of the computing device 110 (e.g., as part of a storage driver).

The file optimizer 140 supports the technologies and solutions described herein for grouping files for optimized file operations. For example, the file optimizer 140 can provide an application programming interface (API) for accessing the file optimizer 140. The API can be accessed by the operating system 130. For example, the operating system 130 can receive file requests from the services and applications 120 via standard operating system operations. The operating system 130 can then use the file optimizer 140 to group and optimize the file requests (e.g., without the services and applications 120 having to be re-written to take advantage of the file optimizer 140). Instead of, or in addition to, the API being accessed by the operating system 130, the API can be accessed directly by the services and applications 120. For example, the services and applications 120 can directly access the file optimizer 140 (e.g., as provided within the operating system 130 and/or as provided by another component, such as storage driver, of the computing device 110).

The file optimizer 140 supports various command and requests related to grouping files for optimized file operations. For example, the file optimizer 140 can support requests to perform file operations for a plurality of files (e.g., to open a multi-file stream). The file optimizer 140 can receive information and operations to perform for each of the plurality of files (e.g., receive file identifiers, such as file names, obtain file handles, lock files, receive data to write for files, etc.). The file optimizer 140 can save data (e.g., data to be written to the files) to a cache (e.g., to cache stored in memory of the computing device 110). The file optimizer 140 can then determine optimized (e.g., aggregated) operations to perform. For example, the file optimizer 140 can determine and perform a reduced number of used sector update operations to perform (e.g., a single used sector table update operation accounting for all of the file operations for the plurality of files). The file optimizer 140 can determine and perform optimized operations to write data for the plurality of files (e.g., for each file, perform a single optimized file operation, or a set of consolidated optimized file operations, to write all the data for that file from the cache to a file storage device, such as an SD card). The file optimizer 140 can determine and perform optimized operations to update folder information (e.g., perform a reduced number of operations, or a single operation, to update all folder meta-data associated with the operations performed for the plurality of files). The file optimizer 140 can provide results of the operations (e.g., report success or failure to other components, such as the operating system 130 and/or the services and applications 120).

### Example 5

### Methods for Performing Optimized File Operations

In any of the examples herein, methods can be provided for performing optimized file operations. For example, optimized file operations can be performed for a group of multiple files (e.g., when using external secondary storage).

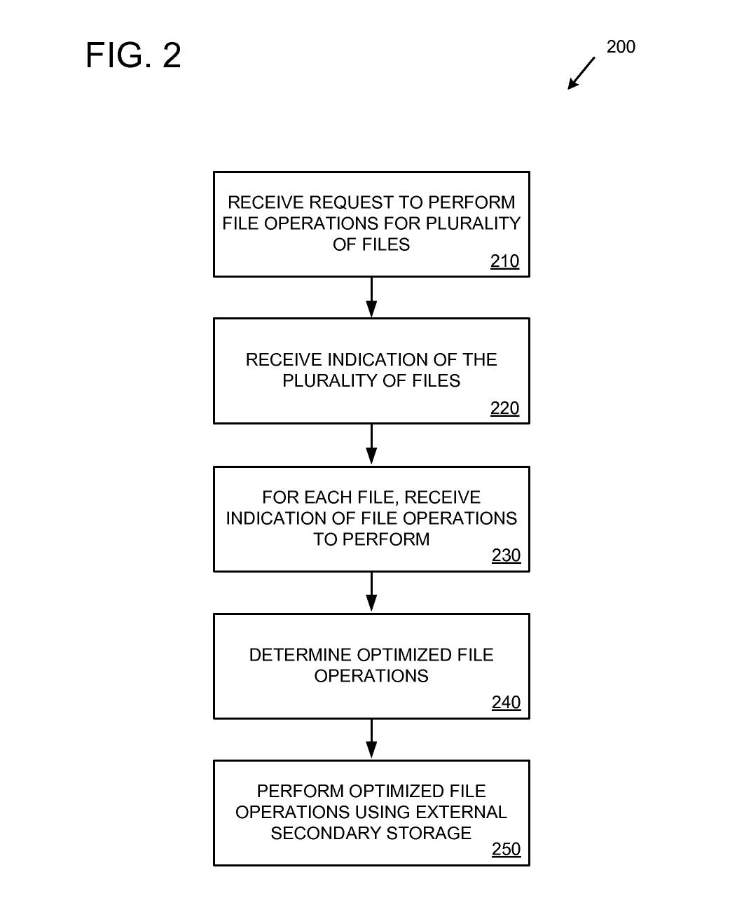

FIG. 2 is a flowchart of an example method 200 for grouping files for optimized file operations. The example method 200 can be performed, for example, by the file optimizer 140 depicted in FIG. 1. At 210, a request is received to perform file operations for a plurality of files. The request can be received, for example, by a component of a computing device (e.g., by a file optimization component via an API of the file optimization component).

At 220, an indication of the plurality of files is received. The indication can comprise file names, path names, file identifiers, file handles, and/or other information identifying or associated with the plurality of files.

At 230, an indication of one or more file operations to perform for each of the plurality of files. For example, the one or more file operations to perform for each file can comprise one or more file write operations, one or more file delete operations, one or more file move operations, etc. For example, if a 1 MB file is being written, the one or more file operations can comprise 100 individual file operations each for writing 10 KB of the 1 MB file.

At 240, optimized file write operations are determined for the plurality of files based on the received indications of file operations 230. The optimized file write operations can comprise a reduced number of operations (e.g., consolidated or aggregated operations). For example, if 100 file write operations are received at 230, the optimized file write operations can comprise a single write operation that aggregates all 100 file operations (e.g., a single 1 MB write operation). As another example, a number of sectors used updates can be optimized as fewer sectors used updates, or a single sectors used update (e.g., to update a sectors used table). In addition to, or instead of, optimized file write operations, other optimized file operations can be determined at 240 and performed.

At 250, the determined optimized write file operations are performed. For example, the optimized file operations can be performed using an external secondary storage device (e.g., an SD card). Performing the optimized file operations can comprise writing data, updating used sector information, updating file/folder information (e.g., folder meta-data), and/or performing other types of optimized file operations.

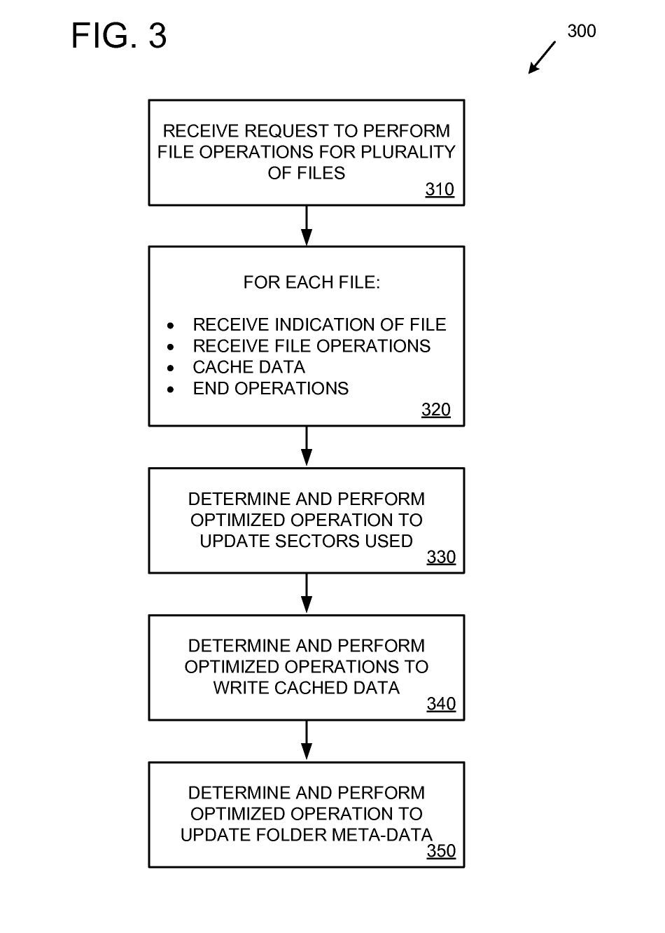

FIG. 3 is a flowchart of another example method 300 for grouping files for optimized file operations. The example method 300 can be performed, for example, by the file optimizer 140 depicted in FIG. 1. At 310, a request is received to perform file operations for a plurality of files. The request can be received, for example, by a component of a computing device (e.g., by a file optimization component via an API of the file optimization component).

At 320, a number of actions are performed for each file of the plurality of files. The actions comprise receiving an indication of the file (e.g., file name, path name, file identifier, file handle, and/or other information identifying or associated with the file). The actions also comprise receiving one or more file operations to perform for the file (e.g., write operations, move operations, etc.). The actions also comprise caching data associated with the one or more file operations to perform for the file (e.g., by caching write data from multiple write operations to cache memory). Finally, the actions comprise receiving an indication that the file operations are complete for the file.

At 330, a single optimized file operation is determined and performed to update a sectors used table (e.g., to update the table on external secondary storage). For example, the used sectors for all files of the plurality of files can be calculated and combined into a single operation that updates the sectors used table.

At 340, optimized file operations to write the cached data for the plurality of files are determined and performed. For example, if 100 file write operations are received at 320 for a particular file (each for writing 10 KB of data) and the write data is cached, the optimized file operations can comprise a single write operation that aggregates all 100 file operations to create a single 1 MB write operation that writes the 1 MB of data from the cache to external secondary storage. As another example, the 100 write operations could be performed as two optimized file write operations, each writing 512 KB of data. As another example, a single write operation can be determined and performed to write data for multiple files (e.g., aggregating 200 file operations, 100 file operations for each of two files each operation for writing 10 KB of data, to create a single 2 MB write operation).

As another example, if many small files are received (e.g., for a mapping program with a file for each ‘tile’ of the map) the optimizer can write multiple files with each large optimized data write. With this solution, a single update of the sector usage (step (b)(i)) can be performed along with a minimum number of large writes to complete storing of all file data.

At 350, optimized file operations are determined and performed to update folder meta-data associated with the plurality of files. For example, a single operation to update folder meta-data for all of the plurality of files can be determined and performed.

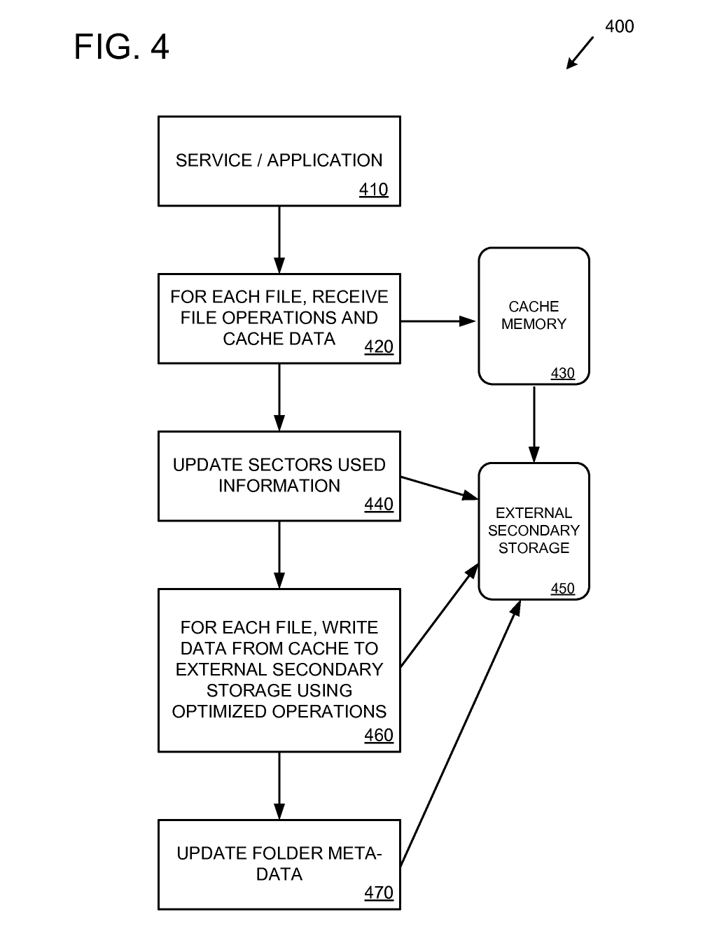

FIG. 4 is a flowchart of another example method 400 for grouping files for optimized file operations using cache memory and external secondary storage. The example method 400 can be performed, for example, by the file optimizer 140 depicted in FIG. 1.

At 410, a service or application initiates a request to perform file operations for a plurality of files (e.g., for a multi-file stream). For example, the service or application can initiate the request by calling an API provided by the operating system or provided by another system component (e.g., by a storage driver). In a specific implementation, the service or application obtains a file handle for a multi-file stream to initiate the request.

At 420, file operations are received from the service or application 410 for each file (e.g., for all files of the plurality of files). The file operations can comprise file write operations, file move operations, file delete operations, file create operations, file lock operations, file handle operations, etc. In a specific implementation, the operations comprise, for each file, locking the file, receiving writing data for the file in one or more operations, and ending operations for the file.

Data (e.g., file data to be written) for the received file operations 420 is stored in cache memory 430. For example, the cache memory can be stored in internal system memory (e.g., RAM or flash) of a computing device.

At 440, a calculation is performed to determine the number of sectors that will be used by the files after the operations are performed. Then, using the calculation, the sectors used information is updated on external secondary storage 450 (e.g., via a single optimized operation to update the sectors used information).

At 460, data from the cache memory 430 for each of the plurality of files (e.g., for all files of the plurality of files) is written to the external secondary storage 450 using optimized operations. For example, if two files are being updated each using 20 file writes of 4 KB chunks, then the data (80 KB for each file) would be stored in the cache memory 430. Then, at 460, one optimized operation could be used to write that file's 80 KB of data from the cache memory 430 to the external secondary storage 450. Instead of one optimized operation, a different number of optimized operations could be used to write the data, where the different number of optimized operations is still fewer than the original 20 file writes.

At 470, folder meta-data is updated using optimized operations. For example, a single optimized operation can be used to update folder meta-data for all files of the plurality of files for which file operations are being performed.

### Example 6

### Information Flow for Performing Optimized File Operations

In any of the examples herein, information flows can be provided for performing optimized file operations. For example, optimized file operations can be performed for a group of multiple files (e.g., when using external secondary storage).

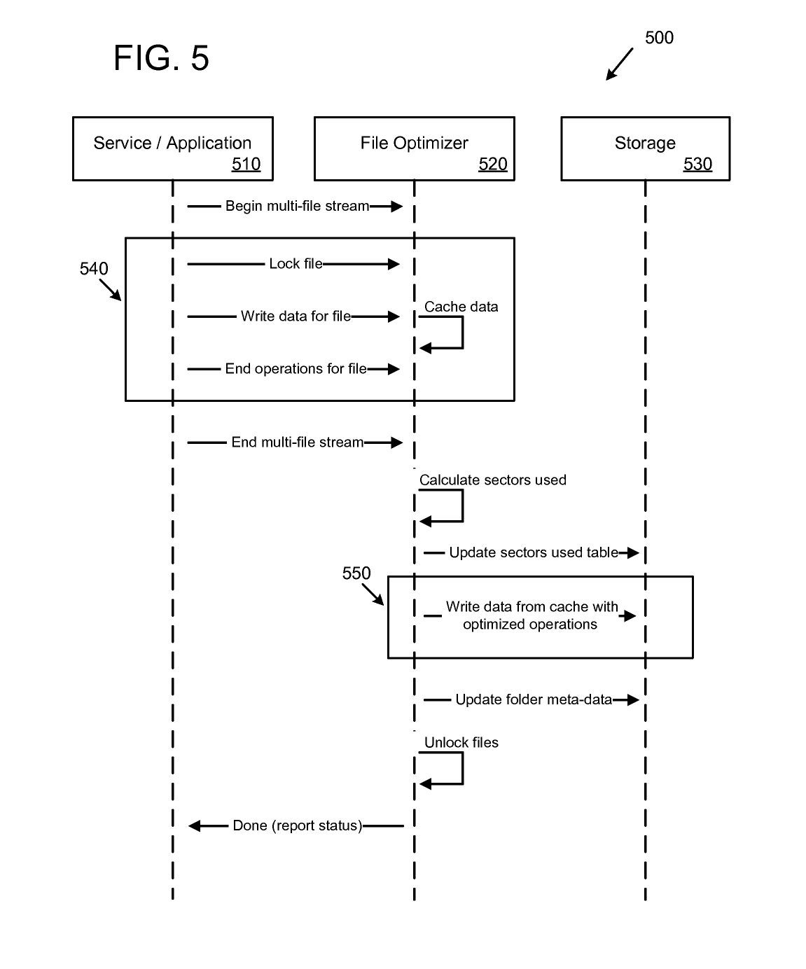

FIG. 5 is a flowchart of an example information flow 500 for grouping files for optimized file operations. In the example information flow 500, a service or application 510 calls a file optimizer component 520 (e.g., provided as part of the operating system or separately) to perform file operations for a plurality of files. Alternatively, an operating system can call the file optimizer 520 (instead of the service or application 510). For example, the operating system can receive file operations from the service or application 510 and call the file optimizer 520 (e.g., so the service or application 510 only has to deal with standard operating system file storage facilities instead of being re-written to take advantage of the file optimizer 520 directly).

As depicted in the example information flow 500, the service or application 510 first sends a request to being a multi-file stream (file operations for a plurality of files). For example, the service or application 510 can begin the multi-file stream by obtaining a multi-file stream handle.

As depicted in the example information flow 500, the service or application 510 next performs a sequence of actions 540 for each file of the plurality of files. The sequence of actions 540 comprise locking the file, writing and caching data for the file, and ending operations for the file. In some implementations, locking the file can be performed automatically by 510 or 520 (e.g., when using file system APIs).

As depicted in the example information flow 500, the service or application 510 next sends a request to end the multi-file stream. The request to end the multi-file stream indicates that the service or application 510 has completed file operations for the plurality of files at 540.

As depicted in the example information flow 500, once the multi-file steam is complete, the file optimizer 520 calculates the sectors that will be used for the plurality of files involved in the multi-file stream. Then, the file optimizer 520 updates a sectors used table of the storage 530 (e.g., external secondary storage, such as an SD card). In a specific implementation, the file optimizer 520 determines and performs a single operation to update the sectors used information (e.g., sectors used table).

As depicted in the example information flow 500, once the multi-file steam is complete, the file optimizer 520 also performs a number of optimized file operations 550 (e.g., a fewer number of operations than those received to write data at 540) to write data from the cache to the storage 530 for each of the plurality of files.

As depicted in the example information flow 500, once the multi-file steam is complete, the file optimizer 520 also updates folder meta-data to reflect changes to the plurality of files (e.g., file size, file name, folder location, etc.). In a specific implementation, the file optimizer 520 determines and performs a single operation to update the folder meta-data information.

After the file optimizer 520 has completed the optimized file operations, it unlocks the plurality of files. The file optimizer 520 can also report status information to the service or application 510, to the operating system, and/or to other components. The status information can comprise an indication of success or failure of the operations.

### Example 7

### Implementation Details

This section describes a specific implementation of a file optimizer component for grouping files for optimized file operations. The elements of the specific implementation can be used separately or in combination. For example, various elements can be combined with the techniques and solutions described elsewhere herein.

In the specific implementation the file optimizer component provides a set of APIs that the OS and/or services and application can call. The file optimizer component receives the data streams (e.g., multi-file streams) and associated meta-data and uses them to organize and optimize the data streams. The file optimizer component manages an amount of memory (e.g., a variable amount of memory) to cache the incoming data streams and then later write the cached data out to the media (e.g., external secondary storage) in an optimized fashion.

The file optimizer component attempts to minimize overhead operations, including the number of times the sectors in use table/bitmap is updated and the number of times the folder meta-data is updated. Reducing these overhead operations can increase the sequential nature of the overall data stream from the media point-of-view, which external secondary storage (e.g., SD cards) may be particularly sensitive to.

The following pseudo-code depicts an example implementation of the file optimizer component (in some implementations, the file optimizer component is called a Blast or BlastFile component):
1. Start—Create file optimizer handle to uniquely identify the multi-file stream
2. BeginFile—Lock a particular file of the multi-file stream so that only this file optimizer handle can access it.
3. Write—Cache/store the data in virtual cache memory for the particular file (e.g., store by file optimizer handle, file identifier, and offset).
4. Read—depending on the implementation the optimizer may support simultaneous read operation on the files under optimization. This may only support reading of the cached data of the files or may also support passthru to the storage itself.
5. EndFile—End file operations for the particular file.
6. AbortFile—Operation to remove data in cache memory for the particular file (e.g., the file may have been a temporary file, or the operation may have been canceled).
7. Stop—After operations for all files of the multi-file stream have been received and cached (e.g., BeginFile, Write, and EndFile have been performed for each file).

Once the operations have been received and cached, the optimization begins:
a. Calculate sectors needed and update the media's used sectors.
b. For each file (e.g., for all files of the multi-file stream): write the data in chunks (e.g., in “X”MB chunks, where “X” is 1 in a specific implementation) in sequential logical block address order as far as possible (e.g., by selecting the first available contiguous LBA space that will hold the file, when possible).
c. Update the folder meta-data.
d. Unlock the files.
e. Release the file optimizer handle (created at 1. Start).

In addition to file operations, other types of operations can be optimized using the techniques and solutions described herein. For example, the following pseudo-code can be used to optimize operations that involve files and a database (e.g., songs and albums, a music database, a picture database, etc.).

1. For each album
a. For each song
   i. Write the song to media (e.g., using file optimization operations)
b. Add song to database
   i. Write data to a transaction log on the media
   ii. Write table data to the media

With the above pseudo-code, optimization can be performed for the (b)(i) and (b)(ii) operations. For example, transaction log updates and/or table data updates can be aggregated to create and perform a single transaction log update and/or a single table data update after all song files have been written.

Another scenario that can be optimized using the techniques described herein is album downloads over cellular networks (or other wireless networks, such as Wi-Fi® networks) to a computing device. Typically to maximize the cellular capacity multiple files are downloaded simultaneously. If the application or service receiving the songs on the device were on a system that provided the proposed optimizer then the song data could be written in a sequential order for the entire album in an optimized manner on the external storage. The same optimizations can benefit other services and apps receiving multiple simultaneous file streams onto such devices.

### Example 8

### Cache Memory

This section describes techniques and solutions that can be applied to manage cache memory for storing data of a multi-file stream. The techniques and solutions described in this section can be applied to the techniques and solutions described elsewhere herein.

In some implementations, there will be enough cache memory to hold the entire set of grouped files needed to be optimized for the multi-file stream. However, in other implementations, there may be a limited amount of cache memory (e.g., not enough to hold the entire set of files in some situations). Regardless of the amount of cache memory available, the file optimizer component can provide a mechanism for writing out the data currently held in the cache when the cache is full.

For example, data for a first set of the files in the multi-file stream can be received and stored in the cache. When the cache is full, optimized file operations can be determined and performed (e.g., sector update operations, file write operations, and/or folder meta-data operations) for those files in the cache. Then, data for a second set of the files in the multi-file stream can be received and stored in the cache, optimized file operations can be determined and performed for the second set, and so on.

### Example 9

### APIs

This section describes various API implementation details that can be applied to the file optimization techniques and solutions described herein.

In some implementations, the operating system can implement the file optimization techniques and solutions itself. For example, the operating system can implement the file optimizer component internally or the operating system can access an internal or external API of the file optimizer component. Using this solution, services and applications can access standard file operations provided by the operating system with the operating system handling the optimization itself.

In other implementations, the operating system (or another component, such as a driver component, a service component, or in some circumstances an application component) can expose an API to enable services and applications to take advantage of the file optimization techniques directly. The following is an example implementation of such an API that can be exposed:

FB_HANDLE FBlast_Start(void)

FileHandle FBlast_BeginFile(FB_Handle, path, AnticipatedFileSize, FileFlags);

Size_t FBlast_Write(FB_Handle, FileHandle, ptrDataBuffer, DataBufferSize)

BOOL FBlast_Read(FB_Handle, FileHandle, ptrDataBuffer, ReadRequestSize)

BOOL FBlast_Seek(FB_Handle, FileHandle, offset, origin);

BOOL FBlast_EndFile(FB_Handle, FileHandle);

BOOL FBlast_AbortFile(FB_Handle, FileHandle);

BOOL FBlast_Stop(FB_Handle)

In yet other implementations, the operating system (or another component, such as a driver component) can expose a smaller or simpler API, with the operating system (or other component) performing some of the operations automatically. The following are example implementations of such smaller/simpler APIs that can be exposed:

An example reduced API set, such as:

a. FB_Handle FBlast_Start( . . . )

b. FBlast_Stop(FB_Handle)

An example of augmenting an already existing OS API, such as:

a. CreateFile, Write, Seek, Read, Close

In the above example API set, the operating system (or other component) could automatically call FBlast_Begin file if no FB_Handle was open for the process, and/or it can automatically associate files opened with CreateFile to the active FB_Handle for the current process.

In yet other implementations, a custom runtime library (e.g., a C runtime library) could implement the file optimization techniques thus encapsulating the APIs. The services and applications using the runtime library would benefit from the improved performance (e.g., without requiring any code changes to the services and applications).

### Example 10

### Computing Systems

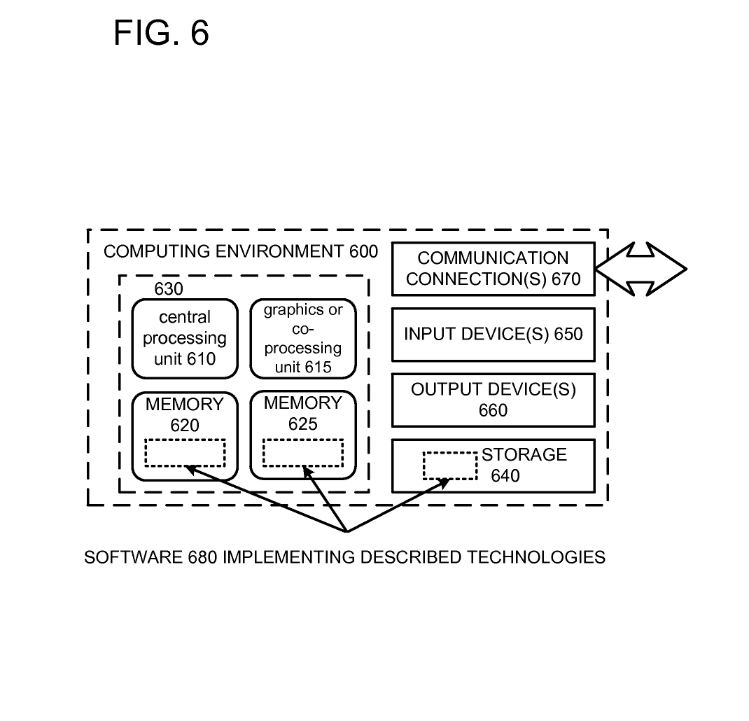

FIG. 6 depicts a generalized example of a suitable computing system 600 in which the described innovations may be implemented. The computing system 600 is not intended to suggest any limitation as to scope of use or functionality, as the innovations may be implemented in diverse general-purpose or special-purpose computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s). The memory 620, 625 stores software 680 implementing one or more innovations described herein, in the form of computer-executable instructions suitable for execution by the processing unit(s).

A computing system may have additional features. For example, the computing system 600 includes storage 640, one or more input devices 650, one or more output devices 660, and one or more communication connections 670. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 may be removable or non-removable, and includes magnetic disks, magnetic tapes or cassettes, CD-ROMs, DVDs, or any other medium which can be used to store information and which can be accessed within the computing system 600. The storage 640 stores instructions for the software 680 implementing one or more innovations described herein.

The input device(s) 650 may be a touch input device such as a keyboard, mouse, pen, or trackball, a voice input device, a scanning device, or another device that provides input to the computing system 600. For video encoding, the input device(s) 650 may be a camera, video card, TV tuner card, or similar device that accepts video input in analog or digital form, or a CD-ROM or CD-RW that reads video samples into the computing system 600. The output device(s) 660 may be a display, printer, speaker, CD-writer, or another device that provides output from the computing system 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 11

### Mobile Device

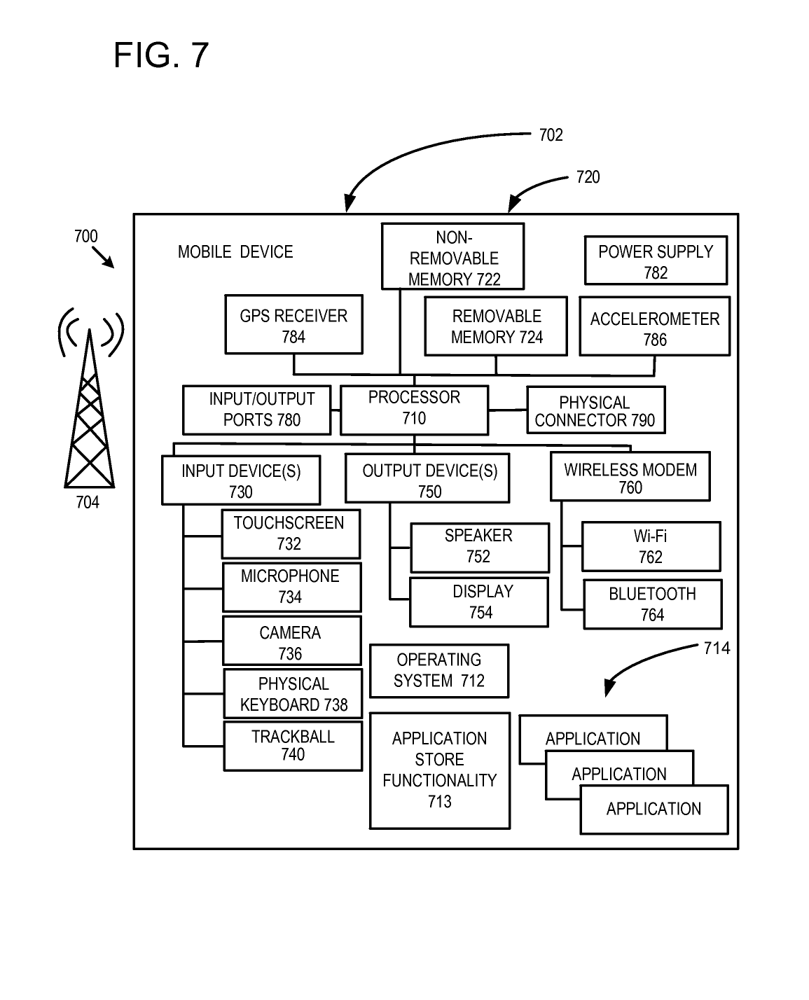

FIG. 7 is a system diagram depicting an exemplary mobile device 700 including a variety of optional hardware and software components, shown generally at 702. Any components 702 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 704, such as a cellular, satellite, or other network.

The illustrated mobile device 700 can include a controller or processor 710 (e.g., signal processor, microprocessor, ASIC, or other control and processing logic circuitry) for performing such tasks as signal coding, data processing, input/output processing, power control, and/or other functions. An operating system 712 can control the allocation and usage of the components 702 and support for one or more application programs 714. The application programs can include common mobile computing applications (e.g., email applications, calendars, contact managers, web browsers, messaging applications), or any other computing application. Functionality 713 for accessing an application store can also be used for acquiring and updating application programs 714.

The illustrated mobile device 700 can include memory 720. Memory 720 can include non-removable memory 722 and/or removable memory 724. The non-removable memory 722 can include RAM, ROM, flash memory, a hard disk, or other well-known memory storage technologies. The removable memory 724 can include flash memory or a Subscriber Identity Module (SIM) card, which is well known in GSM communication systems, or other well-known memory storage technologies, such as “smart cards.” The memory 720 can be used for storing data and/or code for running the operating system 712 and the applications 714. Example data can include web pages, text, images, sound files, video data, or other data sets to be sent to and/or received from one or more network servers or other devices via one or more wired or wireless networks. The memory 720 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 700 can support one or more input devices 730, such as a touchscreen 732, microphone 734, camera 736, physical keyboard 738 and/or trackball 740 and one or more output devices 750, such as a speaker 752 and a display 754. Other possible output devices (not shown) can include piezoelectric or other haptic output devices. Some devices can serve more than one input/output function. For example, touchscreen 732 and display 754 can be combined in a single input/output device.

The input devices 730 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 712 or applications 714 can comprise speech-recognition software as part of a voice user interface that allows a user to operate the device 700 via voice commands. Further, the device 700 can comprise input devices and software that allows for user interaction via a user's spatial gestures, such as detecting and interpreting gestures to provide input to a gaming application.

A wireless modem 760 can be coupled to an antenna (not shown) and can support two-way communications between the processor 710 and external devices, as is well understood in the art. The modem 760 is shown generically and can include a cellular modem for communicating with the mobile communication network 704 and/or other radio-based modems (e.g., Bluetooth 764 or Wi-Fi 762). The wireless modem 760 is typically configured for communication with one or more cellular networks, such as a GSM network for data and voice communications within a single cellular network, between cellular networks, or between the mobile device and a public switched telephone network (PSTN).

The mobile device can further include at least one input/output port 780, a power supply 782, a satellite navigation system receiver 784, such as a Global Positioning System (GPS) receiver, an accelerometer 786, and/or a physical connector 790, which can be a USB port, IEEE 1394 (FireWire) port, and/or RS-232 port. The illustrated components 702 are not required or all-inclusive, as any components can be deleted and other components can be added.

### Example 12

### Cloud-Supported Environment

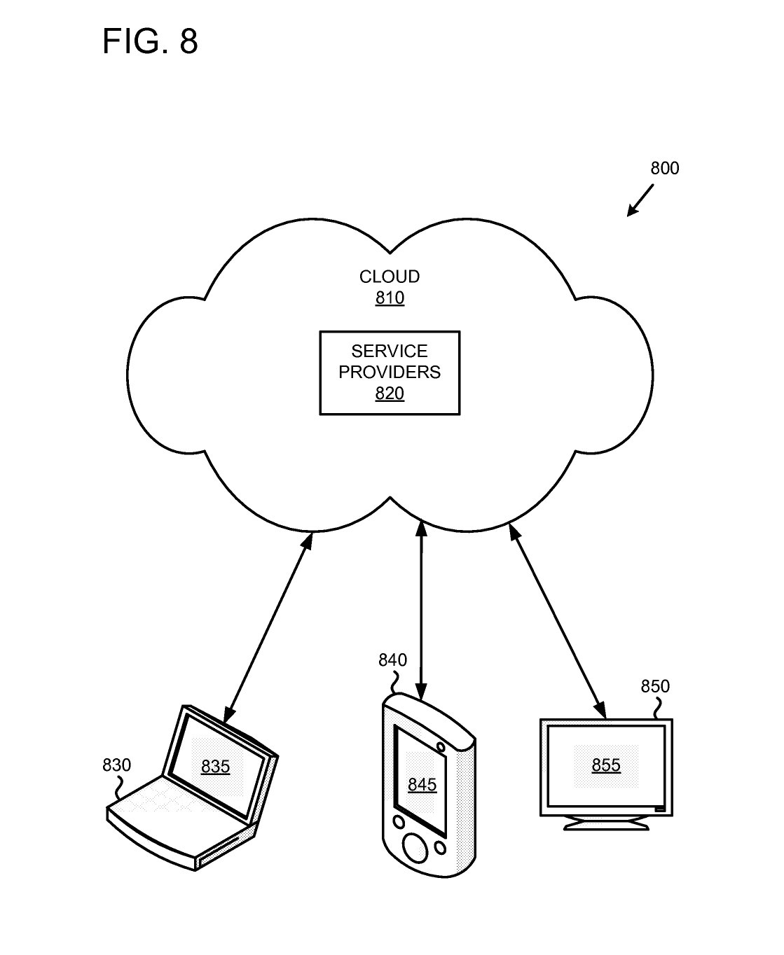

FIG. 8 illustrates a generalized example of a suitable implementation environment 800 in which described embodiments, techniques, and technologies may be implemented. In the example environment 800, various types of services (e.g., computing services) are provided by a cloud 810. For example, the cloud 810 can comprise a collection of computing devices, which may be located centrally or distributed, that provide cloud-based services to various types of users and devices connected via a network such as the Internet. The implementation environment 800 can be used in different ways to accomplish computing tasks. For example, some tasks (e.g., processing user input and presenting a user interface) can be performed on local computing devices (e.g., connected devices 830, 840, 850) while other tasks (e.g., storage of data to be used in subsequent processing) can be performed in the cloud 810.

In example environment 800, the cloud 810 provides services for connected devices 830, 840, 850 with a variety of screen capabilities. Connected device 830 represents a device with a computer screen 835 (e.g., a mid-size screen). For example, connected device 830 could be a personal computer such as desktop computer, laptop, notebook, netbook, or the like. Connected device 840 represents a device with a mobile device screen 845 (e.g., a small size screen). For example, connected device 840 could be a mobile phone, smart phone, personal digital assistant, tablet computer, and the like. Connected device 850 represents a device with a large screen 855. For example, connected device 850 could be a television screen (e.g., a smart television) or another device connected to a television (e.g., a set-top box or gaming console) or the like. One or more of the connected devices 830, 840, 850 can include touch screen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 800. For example, the cloud 810 can provide services for one or more computers (e.g., server computers) without displays.

Services can be provided by the cloud 810 through service providers 820, or through other providers of online services (not depicted). For example, cloud services can be customized to the screen size, display capability, and/or touch screen capability of a particular connected device (e.g., connected devices 830, 840, 850).

In example environment 800, the cloud 810 provides the technologies and solutions described herein to the various connected devices 830, 840, 850 using, at least in part, the service providers 820. For example, the service providers 820 can provide a centralized solution for various cloud-based services. The service providers 820 can manage service subscriptions for users and/or devices (e.g., for the connected devices 830, 840, 850 and/or their respective users).

### Example 13

### Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 6, computer-readable storage media include memory 620 and 625, and storage 640. By way of example and with reference to FIG. 7, computer-readable storage media include memory and storage 720, 722, and 724. The term computer-readable storage media does not include communication connections (e.g., 670, 760, 762, and 764) such as signals and carrier waves.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. I therefore claim as my invention all that comes within the scope and spirit of the claims.

I claim:

1. A method, implemented at least in part by a computing device, for grouping files for optimized file operations, the method comprising:
receiving, by a component of the computing device, a request to perform file operations for a plurality of files;
receiving, by the component of the computing device, an indication of the plurality of files;
for each file of the plurality of files:
receiving, by the component of the computing device, an indication of one or more file operations to perform for the file;
determining, by the component of the computing device, optimized file operations for the plurality of files; and
performing the optimized file operations using external secondary storage of the computing device.

2. The method of claim 1 wherein the request to perform file operations for the plurality of files comprises a request to write data for the plurality of files.

3. The method of claim 1 wherein the component of the computing device is a file optimization component provided by an operating system of the computing device.

4. The method of claim 1 wherein the receiving the indication of one or more file operations to perform for the file comprises:
receiving at least one of a file write operation, a file delete operation, and a file move operation.

5. The method of claim 1 wherein the determining the optimized file operations for the plurality of files comprises:
consolidating a number of sectors used updates.

6. The method of claim 5 wherein consolidating the number of sectors used updates comprises reducing the number of sectors used updates from a plurality of sectors used updates to a single sectors used update.

7. The method of claim 1 wherein the determining the optimized file operations for the plurality of files comprises:
consolidating file write operations for the plurality of files to generate a reduced number of file write operations.

8. The method of claim 1 wherein the determining the optimized file operations for the plurality of files comprises:
consolidating folder meta-data update operations associated with the plurality of files to generate a reduced number of folder meta-data update operations.

9. The method of claim 1 wherein the external secondary storage of the computing device is one of a Secure Digital (SD) storage card, a MultiMediaCard (MMC) storage card, and a Universal Serial Bus (USB) storage device.

10. A computing device comprising:
a processing unit;
memory; and
an external secondary storage card;
the computing device configured to perform operations for grouping files for optimized file operations, the operations comprising:
receiving a request to perform file operations for a plurality of files;
receiving an indication of the plurality of files;
for each file of the plurality of files:
receiving an indication of one or more file operations to perform for the file; and
storing data related to the one or more file operations in a cache, wherein the cache is stored in the memory of the computing device;
determining optimized file operations for the plurality of files based at least in part upon the received indications of one or more file operations to perform for each of the plurality of files; and
performing the optimized file operations using the external secondary storage card of the computing device.

11. The computing device of claim 10 wherein the request to perform file operations for the plurality of files comprises a request to write data for the plurality of files, wherein the data to be written for the plurality of files is stored temporarily in the cache, and wherein the performing the optimized file operations comprises writing the data stored in the cache to the external secondary storage card.

12. The computing device of claim 10 wherein the receiving the indication of one or more file operations to perform for the file comprises:
receiving at least one of a file write operation, a file delete operation, and a file move operation.

13. The computing device of claim 10 wherein the determining the optimized file operations for the plurality of files comprises:
determining an optimized file operation to perform a single update to sectors used information for the plurality of files, wherein the single update is based at least in part upon the received indications of one or more file operations to perform for each of the plurality of files.

14. The computing device of claim 10 wherein the determining the optimized file operations for the plurality of files comprises:
consolidating file write operations for the plurality of files to generate a reduced number of file write operations.

15. The computing device of claim 10 wherein the determining the optimized file operations for the plurality of files comprises:
consolidating folder meta-data update operations associated with the plurality of files to generate a reduced number of folder meta-data update operations.

16. The computing device of claim 10 wherein the external secondary storage card is one of a Secure Digital (SD) storage card, a MultiMediaCard (MMC) storage card, and a Universal Serial Bus (USB) storage device.

17. A computer-readable storage medium storing computer-executable instructions for causing a computing device to perform a method for grouping files for optimized file operations, the method comprising:
receiving a request to perform file operations for a plurality of files;
for each file of the plurality of files:
receiving an indication of the file;
receiving one or more file operations to perform for the file;
caching data associated with the one or more file operations to perform for the file; and
receiving an indication that file operations are complete for the file;
determining and performing a single optimized file operation to update a sectors used table on external secondary storage of the computing device;
determining and performing optimized file operations to write the cached data for the plurality of files to the external secondary storage; and
determining and performing optimized file operations to update folder meta-data associated with the plurality of files on the external secondary storage.

18. The computer-readable storage medium of claim 17 wherein the determining and performing optimized file operations to write the cached data for the plurality of files to the external secondary storage comprises:
determining optimized file write operations to write data using a chunk size that is larger than the received one or more file operations to perform for each of the plurality of files.

19. The computer-readable storage medium of claim 17 wherein the external secondary storage card is one of a Secure Digital (SD) storage card and a MultiMediaCard (MMC) storage card.

20. The computer-readable storage medium of claim 17 wherein the method is provided by an application programming interface (API) of an operating system of the computing device.
